(19) United States
(12) Patent Application Publication
(10) Pub. No.: US 2008/0120910 A1
(43) Pub. Date: May 29, 2008

(54) Light regulating transom shutter equipped with a bead chain

(76) Inventor: Chin-Fu Chen, Taichung City (TW)

Correspondence Address: BIRCH STEWART KOLASCH & BIRCH, PO BOX 747, FALLS CHURCH, VA, 22040-0747, US

(21) Appl. No.: 11/523,636

(22) Filed: Sep. 20, 2006

(51) Int. Cl. E06B 7/096

(52) U.S. Cl. 49/82.1; 49/86.1

(57) ABSTRACT

A light regulating transom shutter including a bead chain and a plurality of ratchet wheels that are coupled to perform transmission, and a regulator to adjust the inclination angle of a plurality of slats located on a frame. The slats have one end coupled respectively with the ratchet wheels. The bead chain can be moved to synchronously drive the ratchet wheels to rotate. By moving the regulator fastened to the bead chain, the ratchet wheels can be moved to drive and rotate the slats at the same time, thereby enable users to adjust the inclination angle of the slats as desired.

### FIELD OF THE INVENTION

The present invention relates to a transom shutter and particularly to a light regulating transom shutter with slats of adjustable inclination angle.

### BACKGROUND OF THE INVENTION

Referring to FIGS. 1 and 2, a conventional transom shutter 1 mainly includes a frame 2 which has a plurality of slats 3 located in the middle in an equally spaced manner. Each of the slats 3 has a left end and a right end pivotally coupled on the frame 2 to allow each slat 3 to be turned. The slats 3 have a front end jointly coupled with a drawing bar 4 in the middle. Hence by moving the drawing bar 4 downwards as shown in FIG. 2, the slats 3 can be swayed downwards in an inclined manner like stacking fish scales to block light. Moving the drawing bar 4 upwards, the slats 3 can be swayed upwards to become horizontal and spaced from one another so that outdoor light can pass through and outdoor air can enter indoors to facilitate air circulation.

However, adjustment of the slats 3 of the conventional transom shutter 1 has to rely on the drawing bar 4 which is located on the front side and spoils the entire visual sight. The aesthetic appeal of the transom shutter 1 suffers. The drawing bar 4 also hinders outdoor light projection and air circulation. Hence it cannot fully meet user's requirements.

### SUMMARY OF THE INVENTION

Therefore the primary object of the present invention is to provide a light regulating transom shutter equipped with a bead chain to maintain overall integration and aesthetic appeal of the transom shutter without affecting projection of outdoor light and air circulation to better meet user's requirements.

The light regulating transom shutter equipped with a bead chain according to the invention includes a frame, a plurality of slats, a plurality of ratchet wheels, a bead chain and a regulator. The slats are hinged on the frame. The ratchet wheels are coupled respectively on one end of the slats in an one-on-one manner on the same side. The bead chain is coupled with all the ratchet wheels at the same time. The regulator is fastened to the bead chain and can be grasped by a user's hand to move the bead chain and drive the ratchet wheels to rotate synchronously, thereby to change the inclination angle of the slats.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional transom shutter in an open condition.

FIG. 2 is a perspective view of a conventional transom shutter in a closed condition.

FIG. 3A is a schematic view of the transom shutter of the invention.

FIG. 3B is a fragmentary enlarged view of FIG. 3A.

FIG. 4 is a perspective view of the transom shutter of the invention.

FIG. 5 is a perspective view of the transom shutter of the invention in a closed condition.

FIG. 6A is a side view of another embodiment of the transom shutter of the invention.

FIG. 6B is a fragmentary enlarged view of FIG. 6A.

FIG. 7 is a perspective view of another embodiment of the transom shutter of the invention.

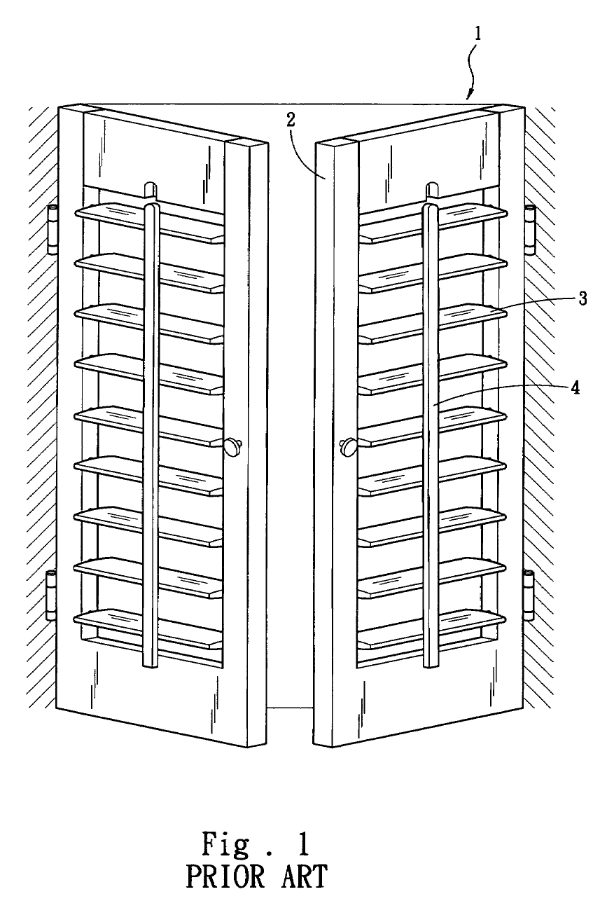

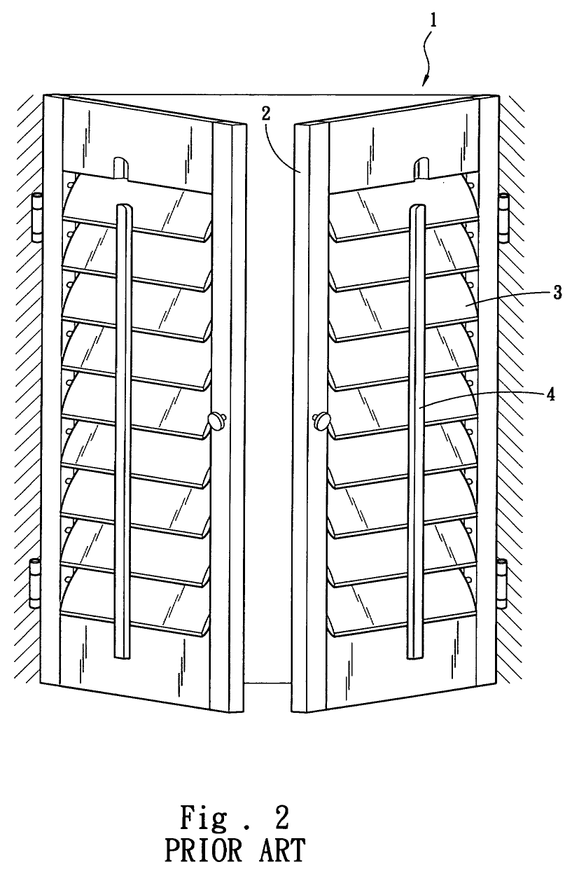

### DETAILED DESCRIPTION OF THE PREFERRED EMBODIMENTS

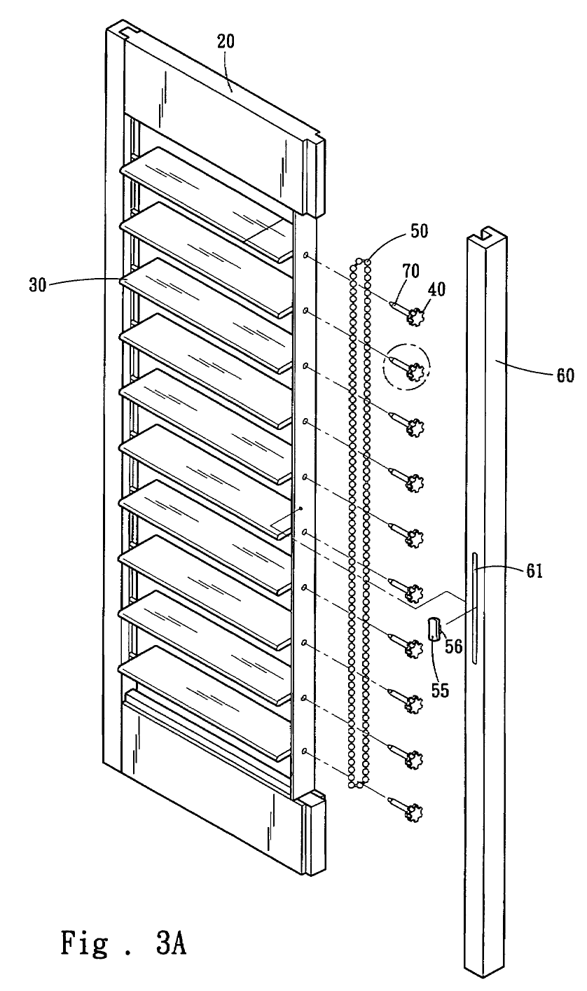

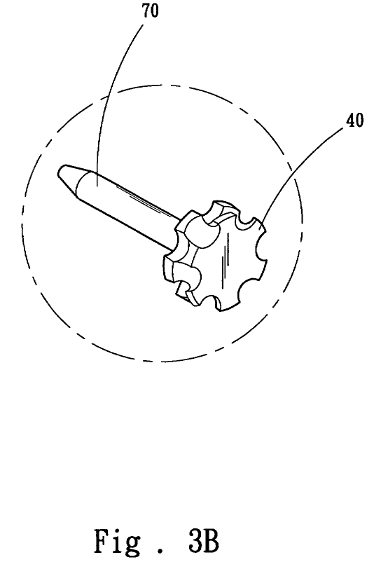

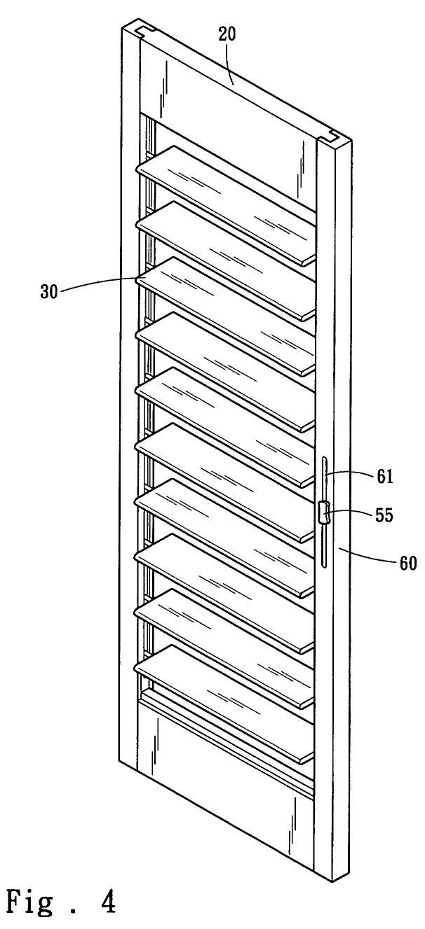

Please refer to FIGS. 3A, 3B and 4, the light regulating transom shutter equipped with a bead chain according to the invention includes a frame 20, a plurality of slats 30, a plurality of ratchet wheels 40, a bead chain 50 and a regulator 55. The slats 30 are hinged on the frame 20. The ratchet wheels 40 are coupled respectively on one end of the slats 30 in an one-on-one manner on the same end. The bead chain 50 is coupled with all the ratchet wheels 40 at the same time. The bead chain 50 can be moved to drive the ratchet wheels 40 to rotate synchronously. It is to be noted that the ratchet wheels 40 may be located outside the frame 20 and fastened respectively to one end of the slats 30 through a pin 70 which runs through the frame 20. The pin 70 also can serve as a hinge joint of each slat 30 and the frame 20. The ratchet wheels 40 may also be located on an inner side of the frame 20 and fastened directly to one end of the slats 30, then the slats 30 are pivotally coupled on the frame 20 through the ratchet wheels 40.

Moreover, the slats 30 may also be engaged with the ratchet wheels 40 and bead chain 50 on two ends to reduce the stress of the ratchet wheels 40 and bead chain 50 during moving, and increase the life span of the ratchet wheels 40 and bead chain 50. To improve aesthetic appeal, the frame 20 may be covered by a frame cover 60 to mask the ratchet wheels 40 and the bead chain 50. The frame cover 60 has a slot 61. The regulator 55 has a clipping pawl 56 running through the slot 61 to be fastened to the bead chain 50.

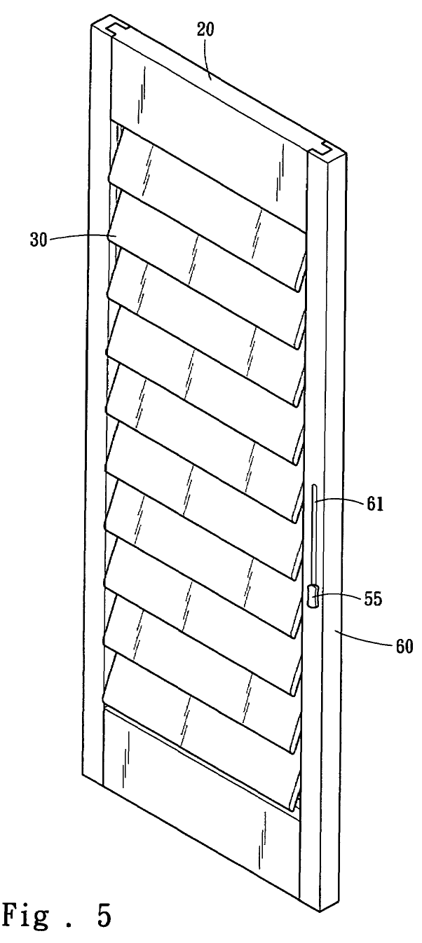

Referring to FIG. 5, by sliding the regulator 55 through a user's hand, the bead chain 50 can be moved, and the ratchet wheels 40 can be driven and rotated synchronously. Thereby the slats 30 also are driven and rotated, and the inclination angle of the slats 30 can be changed at the same time. Thus light regulation and air circulation effects can be achieved.

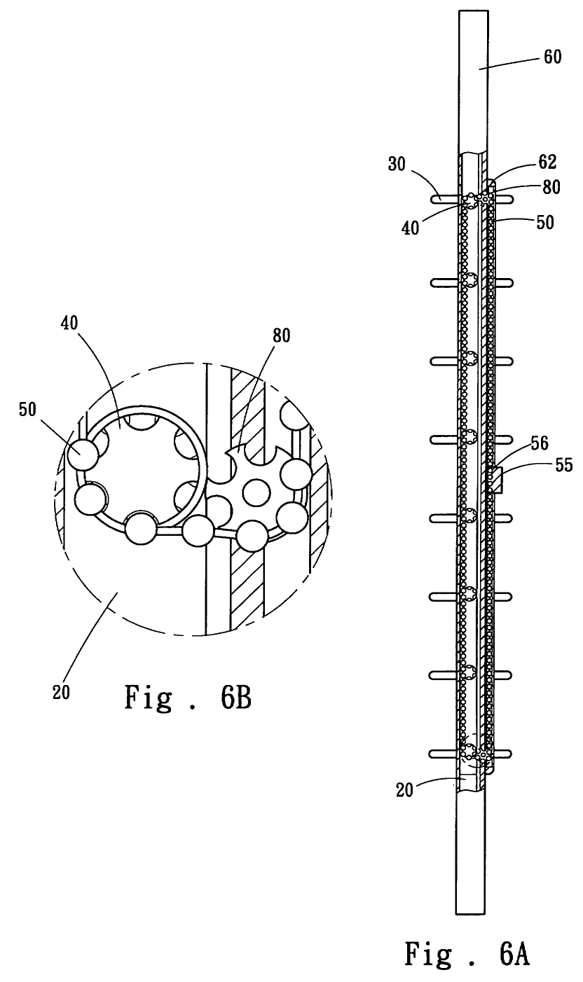

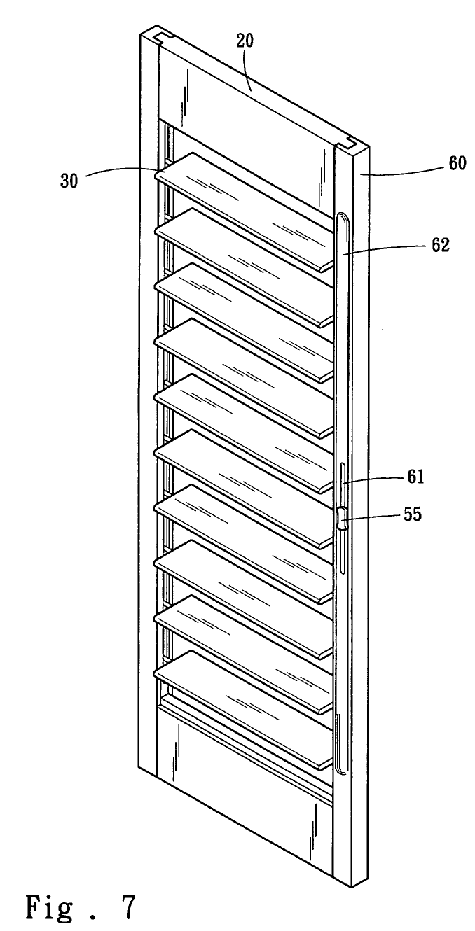

Refer to FIGS. 6A, 6B and 7 for another embodiment of the invention. In this embodiment two transmission gears 80 are included and pivotally coupled on the frame 20 on an upper side and a lower side close to the edges thereof. The bead chain 50 is coupled with the ratchet wheels 40 and the transmission gears 80, and is engaged with the transmission gears 80. The bead chain 50 has a portion tilting outwards and located on an outer side of the frame 20. The frame cover 60 has a housing trough 62 bulging outwards to hold the tilting outward portion of the bead chain 50. The slot 61 is formed on the housing trough 62. The clipping pawl 56 of the regulator 55 runs through the slot 61 to be fastened to the bead chain 50.

By means of the constructions set forth above, the invention is not located in the middle portion of the slats 30, thus does not affect the outside appearance, and also does not affect outdoor light projection and air circulation. In addition, with the frame cover 60 masking the ratchet wheels 40 and bead chain 50, the integrity and appeal of the entire transom shutter can be maintained intact to better meet user's requirements.

What is claimed is:

1. A light regulating transom shutter equipped with a bead chain, comprising:
a frame;
a plurality of slats hinged on the frame;
a plurality of ratchet wheels coupled respectively on one end of the slats on a same side in an one-on-one manner;
a bead chain engaging with the ratchet wheels; and
a regulator fastened to the bead chain.

2. The light regulating transom shutter of claim 1, wherein the ratchet wheels and the bead chain are provided and located on two ends of the slats.

3. The light regulating transom shutter of claim 1, wherein the frame has a frame cover to mask the ratchet wheels and the bead chain, the frame cover having a slot, the regulator having a clipping pawl which runs through the slot and is fastened to the bead chain.

4. The light regulating transom shutter of claim 1, wherein the ratchet wheels are located outside the frame through a pin running through the frame and coupled on the one end of the slats.

5. The light regulating transom shutter of claim 1, wherein the ratchet wheels are located on an inner side the frame and coupled on the one end of the slats, the slats being pivotally coupled on the frame through the ratchet wheels.

6. The light regulating transom shutter of claim 1 further having two transmission gears pivotally coupled on an upper side and a lower side of the frame close to edges thereof, the bead chain being coupled with the ratchet wheels and the transmission gears at the same time and engaged with the transmission gears, and having a portion tilting outwards from the frame.

7. The light regulating transom shutter of claim 6, wherein the frame has a frame cover to mask the ratchet wheels and the bead chain, the frame cover having a housing trough bulging outwards to hold the tilting outward portion of the bead chain, the housing trough having a slot formed thereon, the regulator having a clipping pawl which runs through the slot and is fastened to the bead chain.
